(19) United States
(12) Patent Application Publication
(10) Pub. No.: US 2018/0098543 A1
(43) Pub. Date: Apr. 12, 2018

(54) ANTIMICROBIAL POLYMER SYSTEMS USING MULTIFUNCTIONAL ORGANOMETALLIC ADDITIVES FOR POLYURETHANE HOSTS

(71) Applicant: DMR International, Inc., Woodstock, IL (US)

(72) Inventors: MARC CHASON, Schaumburg, IL (US); Daniel Roman Gamota, San Jose, CA (US); Rick Latella, Woodstock, IL (US)

(21) Appl. No.: 15/838,687

(22) Filed: Dec. 12, 2017

Related U.S. Application Data
(63) Continuation-in-part of application No. 15/708,479, filed on Sep. 19, 2017.
Application No. 15/708,479 is a division of application No. 13/833,445, filed on Mar. 15, 2013, now Pat. No. 9,795,141.
(60) Provisional application No. 61/751,940, filed on Jan. 14, 2013.

(51) Int. Cl. A01N 55/02; A01N 37/02; A01N 59/16; A01N 59/20; A01N 25/10

(52) U.S. Cl. CPC A01N 55/02; A01N 37/02; A01N 59/16; A01N 25/10; A01N 59/20

(57) ABSTRACT

Described are antimicrobial polymer products made from mixtures of antimicrobial organometallic additives dispersed throughout a polymer host matrix. Each of the organometallic additives has a decomposition temperature less than about 200° C. (392° F.).

### CROSS-REFERENCE TO RELATED APPLICATIONS

This application is a continuation-in-part of U.S. application Ser. No. 15/708,479 filed Sep. 19, 2017, which is a divisional of U.S. application Ser. No. 13/833,445, filed Mar. 15, 2013, which claims benefit of priority to U.S. Provisional Patent Application No. 61/751,940, filed Jan. 14, 2013 which is incorporated herein by reference in its entirety.

This application makes reference to International Application No. PCT/IB2013/054604 filed Jun. 4, 2013; U.S. application Ser. No. 13/833,851 filed Mar. 15, 2013; U.S. application Ser. No. 13/833,689, filed Mar. 15, 2013; International Application No. PCT/IB2014/05812708, filed Jan. 8, 2014; U.S. application Ser. No. 15/708,479, filed Sep. 19, 2017; International Application No. PCT/IB2014/05813008, filed Jan. 8, 2014; U.S. application Ser. No. 15/615,860, filed Jun. 7, 2017; U.S. Application No. 61/823,198, filed May 14, 2013; U.S. application Ser. No. 14/277,112, filed May 14, 2014; and International Application No. PCT/IB2015/05256008, filed Apr. 8, 2015. The entire contents and disclosures of these patent applications are incorporated herein by reference.

### BACKGROUND

### Field of the Invention

The present disclosure relates to antimicrobial polymer systems.

### Related Art

Material surfaces of polymer products may become contaminated with disease-causing agents. For example, used in aqueous environments or environments where moisture is present, microbes may be transferred to the surface of the polymer products.

### SUMMARY

According to a first broad aspect, the present disclosure provides a product comprising: a polymer host matrix comprising a thermoplastic, and one or more antimicrobial organometallic additives dispersed throughout the polymer host matrix, wherein each of the one or more antimicrobial organometallic additives has a decomposition temperature less than about 200° C. (392° F.), wherein each of the one or more antimicrobial organometallic additives is water insoluble or sparingly soluble in water and comprises a long-chain fatty acid group, and wherein a majority of metallic species dispersed throughout the polymer host matrix are in the one or more antimicrobial organometallic additives.

According to a second broad aspect, the present disclosure provides a method comprising the following step: (a) mixing one or more antimicrobial organometallic additives with a liquid thermoplastic below a processing temperature to form a polymer product comprising the one or more antimicrobial organometallic additives dispersed throughout the polymer host matrix, wherein each of the one or more antimicrobial organometallic additives is water insoluble or sparingly soluble in water and comprises a long-chain fatty acid group, wherein a majority of metallic species dispersed throughout the polymer host matrix are in the one or more antimicrobial organometallic additives.

According to a third broad aspect, the present disclosure provides a product comprising: a polymer host matrix comprising a thermoplastic, and one or more antimicrobial organometallic additives dispersed throughout the polymer host matrix, wherein each of the one or more antimicrobial organometallic additives has a decomposition temperature less than about 200° C. (392° F.), wherein the one or more antimicrobial organometallic additives comprise a mixture of two or more members of the group consisting of the following antimicrobial organometallic additives: silver stearate, cupric stearate and zinc stearate.

### BRIEF DESCRIPTION OF THE DRAWINGS

The accompanying drawings, which are incorporated herein and constitute part of this specification, illustrate exemplary embodiments of the invention, and, together with the general description given above and the detailed description given below, serve to explain the features of the invention. The sizes and the relative heights, widths, diameters, thicknesses, etc. of features in the drawings are not necessarily to scale unless specifically indicated otherwise. For example, in the drawings the thickness of a coating in the drawings may be shown thicker relative to the substrate on which the coating is coated to allow for details of the components of the coating to be better illustrated. Also in the drawings, organometallic additives are shown as being much larger than these components would be in the polymer host matrix in which these components are dispersed for ease of illustration. In the drawings, the organometallic additives are depicted as circles. This is only a schematic representation as the additive form factor of the present disclosure may be circular, spherical, linear, branched or other form factor.

FIG. 1 is a schematic drawing of a polymer product having dispersed therein an organometallic additive according to one embodiment of the present disclosure.

FIG. 2 is a schematic drawing of a polymer product having dispersed therein three organometallic additives according to one embodiment of the present disclosure.

FIG. 3 is a schematic drawing of a polymer coating having dispersed therein three organometallic additives on a substrate according to one embodiment of the present disclosure.

FIG. 4 is a schematic drawing of a composite product including a polymer layer having dispersed therein three organometallic additives and a polymer edge coating having dispersed therein three organometallic additives according to one embodiment of the present disclosure.

FIG. 5 is a schematic drawing of a composite product including two polymer layers having dispersed therein three organometallic additives and a polymer edge coating having dispersed therein three organometallic additives according to one embodiment of the present disclosure.

FIG. 6 is a schematic drawing of a composite product including two polymer layers having dispersed therein three organometallic additives and a polymer edge coating having dispersed therein three organometallic additives according to one embodiment of the present disclosure.

FIG. 7 is a schematic drawing of a elongated polymer product having dispersed therein three organometallic additives according to one embodiment of the present disclosure.

FIG. 8 is a cross-sectional view of the product of FIG. 7.

FIG. 9 is a schematic drawing of a reinforced polymer product having dispersed therein three organometallic additives according to one embodiment of the present disclosure.

FIG. 10 is a cross-sectional view of the product of FIG. 9.

FIG. 11 is a schematic drawing of a spherical core-containing polymer product having dispersed therein three organometallic additives according to one embodiment of the present disclosure.

FIG. 12 is a cross-sectional view of the product of FIG. 11.

FIG. 13 is a schematic drawing of a rectangular box-shaped core-containing polymer product having dispersed therein three organometallic additives according to one embodiment of the present disclosure.

FIG. 14 is a cross-sectional view of the product of FIG. 13.

### DETAILED DESCRIPTION OF THE PREFERRED EMBODIMENTS

### Definitions

Where the definition of terms departs from the commonly used meaning of the term, applicant intends to utilize the definitions provided below, unless specifically indicated.

For purposes of the present disclosure, it should be noted that the singular forms, “a,” “an,” and “the” include reference to the plural unless the context as herein presented clearly indicates otherwise.

For purposes of the present disclosure, directional terms such as “top,” “bottom,” “upper,” “lower,” “above,” “below,” “left,” “right,” “horizontal,” “vertical,” “up,” “down,” etc. are merely used for convenience in describing the various embodiments of the present disclosure. The embodiments of the present disclosure may be oriented in various ways. For example, the diagrams, apparatuses, etc. shown in the drawing figures may be flipped over, rotated by 90° in any direction, reversed, etc.

For purposes of the present disclosure, a value or property is “based” on a particular value, property, the satisfaction of a condition or other factor, if that value is derived by performing a mathematical calculation or logical decision using that value, property, the satisfaction of a condition or other factor.

For purposes of the present disclosure, the term “ acrylonitrile butadiene styrene” (ABS) refers to a terpolymer made by polymerizing styrene and acrylonitrile in the presence of polybutadiene. The proportions can vary from 15 to 35% acrylonitrile, 5 to 30% butadiene and 40 to 60% styrene. The result is a long chain of polybutadiene criss-crossed with shorter chains of poly(styrene-co-acrylonitrile). The nitrile groups from neighboring chains, being polar, attract each other and bind the chains together, making ABS stronger than pure polystyrene. The styrene gives the plastic a shiny, impervious surface. The polybutadiene, a rubbery substance, provides toughness even at low temperatures. For the majority of applications, ABS can be used between −20 and 80° C. (−4 and 176° F.) as its mechanical properties vary with temperature. The properties are created by rubber toughening, where fine particles of elastomer are distributed throughout the rigid matrix. Additional reference to exemplary disclosed embodiments may be referenced at: https://www.creativemechanisms.com/blog/everything-you-need-to-know-about-abs-plastic herein incorporated by reference in its entirety.

For purposes of the present disclosure, the term “antimicrobial” refers to a material that kills or inhibits the growth of microorganisms such as bacteria, viruses, fungi, molds or protozoans.

For purposes of the present disclosure, the term “antimicrobial organometallic additive” refers to an organometallic additive that imparts antimicrobial properties to a product of which the antimicrobial organometallic additive is a part or increases the antimicrobial properties of a product of which the antimicrobial organometallic additive is a part.

For purposes of the present disclosure, the term “degree of antimicrobial activity” refers to the percentage reduction in Colony Forming Units (CFU) observed when a polymer product is subjected to JIS Z 2801 test protocol described below in the Examples section. For example, if a 99.99831% reduction in Colony Forming Units (CFU) is observed for a polymer product, the product has a 99.99831% degree of antimicrobial activity.

For purposes of the present disclosure, the term “dispersed throughout” refers to one or more antimicrobial organometallic additives being distributed relatively evenly throughout a polymer host matrix.

For purposes of the present disclosure, the term “high-density polyethylene” (HDPE) refers to a polyethylene thermoplastic made from petroleum. HDPE may be referred to as “alkathene” or “polythene” when used for pipes. With a high strength-to-density ratio, HDPE may be used in the production of plastic bottles, corrosion-resistant piping, geomembranes, and plastic lumber. HDPE is known for its large strength-to-density ratio. The density of HDPE can range from 0.93 to 0.97 g/cm³ or 970 kg/m³. Although the density of HDPE is only marginally higher than that of low-density polyethylene, HDPE has little branching, giving it stronger intermolecular forces and tensile strength than low-density polyethylene (LDPE). The difference in strength exceeds the difference in density, giving HDPE a higher specific strength. It is also harder and more opaque and can withstand somewhat higher temperatures (120° C./248° F. for short periods). The physical properties of HDPE can vary depending on the molding process that is used to manufacture a specific sample; to some degree a determining factor are the international standardized testing methods employed to identify these properties for a specific process.

For purposes of the present disclosure, the term “long-chain fatty acid” refers to a fatty acid having an aliphatic tail of 13 or more carbon atoms.

For purposes of the present disclosure, the term “long-chain fatty acid group” refers to the ester group derived from a long-chain fatty acid. An example of a long-chain fatty acid group is a stearate group.

For purposes of the present disclosure, the term “low-density polyethylene” (LDPE) refers to a thermoplastic made from a monomer ethylene. LDPE is defined by a density range of 0.910-0.940 g/cm3. LDPE has excellent resistance (no attack/no chemical reaction) to dilute and concentrated acids, alcohols, bases and esters. LDPE has good resistance (minor attack very low chemical reactivity) to aldehydes, ketones and vegetable oils. LDPA has limited resistance (moderate attack / significant chemical reaction, suitable for short-term use only) to aliphatic and aromatic hydrocarbons, mineral oils, and oxidizing agents. LDPE is widely used for manufacturing various containers, dispensing bottles, wash bottles, tubing, plastic bags for computer components, and various molded laboratory equipment. It is commonly used in plastic bags. Other applications for products may include: trays and general purpose containers, corrosion-resistant work surfaces, parts that need to be weldable and machinable, parts requiring flexibility, soft and pliable parts such as snap-on lids, six pack rings, beverage containers made of liquid packaging board, a laminate of paperboard and LDPE (as the waterproof inner and outer layer), and often with of a layer of aluminum foil (thus becoming aseptic packaging), packaging for computer hardware (such as hard disk drives, screen cards, and optical disc drives), playground equipment such as slides, and plastic wraps.

For purposes of the present disclosure, the term “majority” refers to a majority by molar amount. For example, if there were a mixture of antimicrobial organometallic additives comprising 1.0 mole of cupric stearate and 1.0 mole of silver stearate present in a polymer product, 0.1 total moles of metals in a UV absorber dispersed throughout the polymer product and 0.2 moles of metal ions in a color in the polymer product, the antimicrobial organometallic additives would constitute a majority of the metallic species in the polymer product: 2.0 total moles of antimicrobial organometallic additives to 0.3 total moles of metallic species from other sources dispersed throughout the polymer.

For purposes of the present disclosure, the term “metallic species” refers to the metals, metal ions and metal-containing compounds present in a polymer product, depending on the polymer product. In addition to the metals in the antimicrobial organometallic additive of the present disclosure, polymer products of the present disclosure may also include metallic species that are metals, metal ions and metal-containing compounds such as metal salts, metal oxides, organometallic oxides, etc.

For purposes of the present disclosure, the term “organometallic additive” refers to a compound including a metal bound to an organic radical, where the metal species has a valence state of +1, +2, +3, etc.

For purposes of the present disclosure, the term “ plastics extrusion” refers to a high-volume manufacturing process in which raw plastic is melted and formed into a continuous profile. Extrusion may produce items such as plastic films and sheeting, and thermoplastic coatings. In some disclosed embodiments, plastics extrusion may include feeding plastic material (e.g., pellets, granules, flakes or powders) from a hopper into the barrel of an extruder. The material is gradually melted such as by the mechanical energy generated by turning screws and by heaters arranged along the barrel. The molten polymer is then forced into a die, which shapes the polymer into a shape that hardens during cooling. Plastics extrusion may include polymer extrusion.

For purposes of the present disclosure, the term “ polycarbonate” (PC) refers to a group of thermoplastic polymers containing carbonate groups in their chemical structures. Polycarbonates received their name because they are polymers containing carbonate groups (—O—(C═O)—O—). Additional reference to exemplary disclosed embodiments may be referenced at: https://www.creativemechanisms.com/blog/everything-you-need-to-know-about-polycarbonate-pc herein incorporated by reference in its entirety.

For purposes of the present disclosure, the term “polyester” (PET or PETE) refers to a category of polymers that contain the ester functional group in their main chain. As a specific material, it most commonly refers to a type called polyethylene terephthalate (PET). Polyesters include naturally occurring chemicals, such as in the cutin of plant cuticles, as well as synthetics through step-growth polymerization such as polybutyrate. Natural polyesters and a few synthetic ones are biodegradable, but most synthetic polyesters are not. The material is used extensively in clothing. Polyester is a term often defined as long-chain polymers chemically composed of at least 85% by weight of an ester and a dihydric alcohol and a terephthalic acid. Polyester also refers to the various polymers in which the backbones are formed by the esterification condensation of polyfunctional alcohols and acids. Polyester can also be classified as saturated and unsaturated polyesters. Saturated polyesters refer to that family of polyesters in which the polyester backbones are saturated. They are thus not as reactive as unsaturated polyesters. They consist of low molecular weight liquids used as plasticizers and as reactants in forming urethane polymers, and linear, high molecular weight thermoplastics such as polyethylene terephthalate (Dacron and Mylar). Usual reactants for the saturated polyesters are a glycol and an acid or anhydride. Unsaturated polyesters refer to that family of polyesters in which the backbone consists of alkyl thermosetting resins characterized by vinyl unsaturation. They are mostly used in reinforced plastics. These are the most widely used and economical family of resins. Additional reference to exemplary disclosed embodiments may be referenced at: https://www.creativemechanisms.com/blog/everything-about-polyethylene-terephthalate-pet-polyester herein incorporated by reference in its entirety.

For purposes of the present disclosure, the term “polyethylene” (PE) refers to a thermoplastic polymer with variable crystalline structure and an extremely large range of applications depending on the particular type. It is one of the most widely produced plastics in the world. Many kinds of polyethylene are known, with most having the chemical formula (C₂H₄)ₙ. PE is usually a mixture of similar polymers of ethylene with various values of n. Polyethylene is of low strength, hardness and rigidity, but has a high ductility and impact strength as well as low friction. It shows strong creep under persistent force, which can be reduced by addition of short fibers. It feels waxy when touched. The usefulness of polyethylene is limited by its melting point of 80° C. (176° F.) (HDPE, types of low crystalline softens earlier). For common commercial grades of medium- and high-density polyethylene the melting point is typically in the range 120 to 180° C. (248 to 356° F.). The melting point for average, commercial, low-density polyethylene is typically 105 to 115° C. (221 to 239° F.). These temperatures vary strongly with the type of polyethylene. Polyethylene consists of nonpolar, saturated, high molecular weight hydrocarbons. Therefore, its chemical behavior is similar to paraffin. The individual macromolecules are not covalently linked. Because of their symmetric molecular structure, they tend to crystallize; overall polyethylene is partially crystalline. Higher crystallinity increases density and mechanical and chemical stability. Most LDPE, MDPE, and HDPE grades have excellent chemical resistance, meaning they are not attacked by strong acids or strong bases, and are resistant to gentle oxidants and reducing agents. Crystalline samples do not dissolve at room temperature. Polyethylene (other than cross-linked polyethylene) usually can be dissolved at elevated temperatures in aromatic hydrocarbons such as toluene or xylene, or in chlorinated solvents such as trichloroethane or trichlorobenzene. Polyethylene absorbs almost no water. The gas and water vapor permeability (only polar gases) is lower than for most plastics; oxygen, carbon dioxide and flavorings on the other hand can pass it easily. PE can become brittle when exposed to sunlight, carbon black is usually used as a UV stabilizer. Polyethylene cannot be imprinted or stuck together without pretreatment. Additional reference to exemplary disclosed embodiments may be referenced at: https://www.creativemechanisms.com/blog/polyethylene-pe-for-prototypes-3d-printing-and-cnc herein incorporated by reference in its entirety.

For purposes of the present disclosure, the term “polymer” refers to a large molecule, or macromolecule, composed of many repeated subunits. Polymers may range from familiar synthetic plastics such as polystyrene to natural biopolymers such as DNA and proteins that are fundamental to biological structure and function. Polymers, both natural and synthetic, are created via polymerization of many small molecules, known as monomers. Their consequently large molecular mass relative to small molecule compounds produces unique physical properties, including toughness, viscoelasticity, and a tendency to form glasses and semicrystalline structures rather than crystals.

For purposes of the present disclosure, the term “polymer host matrix” refers to a polymer or mixtures of polymers in which one or more antimicrobial organometallic additives are dispersed. A polymer may be a copolymer. A polymer host matrix includes components in addition to the polymer that do not react with the organometallic additives dispersed in the polymer host matrix. For example, the polymer host matrix may be fiberglass which comprises a polymer having dispersed therein glass fibers. Other fibers, such as carbon or graphene, metals and ceramics may also be used, as well as polymer fibers such as Kevlar® (DuPont's registered trademark for a para-aramid synthetic fiber).

For purposes of the present disclosure, the term “ polypropylene” (PP) refers a thermoplastic “addition polymer” made from the combination of propylene monomers. It is used in a variety of applications to include, for example, packaging for consumer products, plastic parts for various industries including the automotive industry, special devices like living hinges, and textiles. An addition polymer made from the monomer propylene, it is rugged and unusually resistant to many chemical solvents, bases and acids. Polypropylene has a relatively slippery “low energy surface” that means that many common glues will not form adequate joints. Joining of polypropylene is often done using welding processes. Polypropylene is in many aspects similar to polyethylene, especially in solution behaviour and electrical properties. The additionally present methyl group improves mechanical properties and thermal resistance, while the chemical resistance decreases. The properties of polypropylene depend on the molecular weight and molecular weight distribution, crystallinity, type and proportion of comonomer (if used) and the isotacticity. In isotactic polypropylene, for example, the CH3 groups are oriented on one side of the carbon backbone. This creates a greater degree of crystallinity and results in a stiffer material that is more resistant to creep than both atactic polypropylene and polyethylene. The density of PP is between 0.895 and 0.92 g/cm³. Therefore, PP is the commodity plastic with the lowest density. With lower density, moldings parts with lower weight and more parts of a certain mass of plastic can be produced. Unlike polyethylene, crystalline and amorphous regions differ only slightly in their density. However, the density of polyethylene can significantly change with fillers. The Young's modulus of PP is between 1300 and 1800 N/mm². Polypropylene is normally tough and flexible, especially when copolymerized with ethylene. This allows polypropylene to be used as an engineering plastic, competing with materials such as acrylonitrile butadiene styrene (ABS). Polypropylene is reasonably economical. Polypropylene has good resistance to fatigue. The melting point of polypropylene occurs at a range, so a melting point is determined by finding the highest temperature of a differential scanning calorimetry chart. Perfectly isotactic PP has a melting point of 171° C. (340° F.). Commercial isotactic PP has a melting point that ranges from 160 to 166° C. (320 to 331° F.), depending on atactic material and crystallinity Syndiotactic PP with a crystallinity of 30% has a melting point of 130° C. (266° F.). Below 0° C., PP becomes brittle. The thermal expansion of polypropylene is very large, but somewhat less than that of polyethylene. Polypropylene is liable to chain degradation from exposure to heat and UV radiation such as that present in sunlight. Oxidation usually occurs at the tertiary carbon atom present in every repeat unit. A free radical is formed here, and then reacts further with oxygen, followed by chain scission to yield aldehydes and carboxylic acids. In external applications, it shows up as a network of fine cracks and crazes that become deeper and more severe with time of exposure. For external applications, UV-absorbing additives must be used. Carbon black also provides some protection from UV attack. The polymer can also be oxidized at high temperatures, a common problem during molding operations. Anti-oxidants are normally added to prevent polymer degradation. Additional reference to exemplary disclosed embodiments may be referenced at: https://www.creativemechanisms.com/blog/all-about-polypropylene-pp-plastic and http://web.rtpcompany.com/info/data/permastat/PermaStat100.htm herein incorporated by reference in its entirety.

For purposes of the present disclosure, the term “polystyrene” (PS) refers to a synthetic aromatic polymer made from the monomer styrene. Polystyrene can be solid or foamed. General-purpose polystyrene is clear, hard, and rather brittle. It is an inexpensive resin per unit weight. It is a rather poor barrier to oxygen and water vapour and has a relatively low melting point. Polystyrene can be naturally transparent, but can be colored with colorants. Uses include protective packaging (such as packing peanuts and CD and DVD cases), containers (such as “clamshells”), lids, bottles, trays, tumblers, disposable cutlery, and in the making of models. In chemical terms, polystyrene is a long chain hydrocarbon wherein alternating carbon centers are attached to phenyl groups (the name given to the aromatic ring benzene). As a thermoplastic polymer, polystyrene is in a solid (glassy) state at room temperature but flows if heated above about 100° C., its glass transition temperature. It becomes rigid again when cooled. This temperature behaviour is exploited for extrusion (as in Styrofoam) and also for molding and vacuum forming, since it can be cast into molds with fine detail. Additional reference to exemplary disclosed embodiments may be referenced at: https://www.creativemechanisms.com/blog/polystyrene-ps-plastic herein incorporated by reference in its entirety.

For purposes of the present disclosure, the term “polyurethane” (PUR and PU) refers to a polymer composed of organic units joined by carbamate (urethane) links. Polyurethane polymers are formed by reacting a di- or poly-isocyanate with a polyol. Both the isocyanates and polyols used to make polyurethanes contain, on average, two or more functional groups per molecule. Polyurethanes may be utilized in the manufacture of high-resilience foam seating, rigid foam insulation panels, microcellular foam seals and gaskets, durable elastomeric wheels and tires (such as roller coaster, escalator, shopping cart, elevator, and skateboard wheels), automotive suspension bushings, electrical potting compounds, high performance adhesives, surface coatings and surface sealants, synthetic fibers, carpet underlay, hard-plastic parts (e.g., for electronic instruments), and hoses. Polyurethanes are in the class of compounds called reaction polymers, which include epoxies, unsaturated polyesters, and phenolics. Polyurethanes are produced by reacting an isocyanate containing two or more isocyanate groups per molecule (R—(N═C═O)ₙ) with a polyol containing on average two or more hydroxyl groups per molecule (R′—(OH)ₙ) in the presence of a catalyst or by activation with ultraviolet light. Additional reference to exemplary disclosed embodiments may be referenced at: http://www.fostercomp.com/sites/default/files/pdf/Foster%20TPU%20TPU%200Processing%20Guidelines.pdf herein incorporated by reference in its entirety.

For purposes of the present disclosure, the term “polyvinyl chloride” (PVC) refers to a synthetic resin made from the polymerization of vinyl chloride. PVC is used in an enormous range of domestic and industrial products, for example, from raincoats and shower curtains to window frames and indoor plumbing. A lightweight, rigid plastic in its pure form, it is also manufactured in a flexible “plasticized” form. Vinyl chloride, also known as chloroethylene, is most often obtained by reacting ethylene with oxygen and hydrogen chloride over a copper catalyst. It is a toxic and carcinogenic gas that is handled under special protective procedures. PVC is made by subjecting vinyl chloride to highly reactive compounds known as free-radical initiators. Under the action of the initiators, the double bond in the vinyl chloride monomers (single-unit molecules) is opened, and one of the resultant single bonds is used to link together thousands of vinyl chloride monomers to form the repeating units of polymers (large, multiple-unit molecules). Pure PVC finds application in the construction trades, where its rigidity, strength, and flame resistance are useful in pipes, conduits, siding, window frames, and door frames. It is also blow-molded into clear, transparent bottles. Because of its rigidity, it must be extruded or molded above 100° C. (212° F.)—a temperature high enough to initiate chemical decomposition (in particular, the emission of hydrogen chloride [HCl]). Decomposition can be reduced by the addition of stabilizers, which are mainly compounds of metals such as cadmium, zinc, tin, or lead. Additional reference to exemplary disclosed embodiments may be referenced at: https://www.creativemechanisms.com/blog/everything-you-need-to-know-about-pvc-plastic herein incorporated by reference in its entirety.

For purposes of the present disclosure, the term “room temperature” refers to a temperature of from about 20° C. to about 25° C.

For purposes of the present disclosure, the term “a solid solution in a polymer host matrix” refers to an organometallic additive mechanically dispersed throughout and suspended within the polymer host matrix.

For purposes of the present disclosure, the term “sparingly soluble in water” refers to a substance having a solubility of less than 0.1 g per 100 ml of water to 1 g per 100 ml of water. Unless specified otherwise, the term “sparingly soluble” and “sparingly soluble in water” are used interchangeably in the description of the invention below to refer to substances that are sparingly soluble in water.

For purposes of the present disclosure, the term “sterile” refers to being free from living germs or microorganisms; aseptic.

For purposes of the present disclosure, the term “thermal injection molding” refers to a manufacturing process for producing parts by injecting material into a mold. Thermal injection molding may be performed with a host of materials including elastomers, thermoplastic and thermosetting polymers. Material for a prescribed part may be fed into a heated container such as a barrel, mixed, and forced into a mold cavity, where it cools and hardens to the configuration of the cavity.

For purposes of the present disclosure, the term “thermoplastic polyurethane” (TPU) refers to a class of polyurethane plastics with many properties, including elasticity, transparency, and resistance to oil, grease and abrasion. TPU may be considered as thermoplastic elastomers consisting of linear segmented block copolymers composed of hard and soft segments. TPU is a block copolymer consisting of alternating sequences of hard and soft segments or domains formed by the reaction of: (1) diisocyanates with short-chain diols and (2) diisocyanates with long-chain diols. By varying the ratio, structure and/or molecular weight of the reaction compounds, an variety of different TPU can be produced. This allows urethane chemists to fine-tune the polymer's structure to the desired final properties of the material. Additional reference to exemplary disclosed embodiments may be referenced at: http://www.fostercomp.com/sites/default/files/pdf/Foster%20TPU%20TPU%200Processing%20Guidelines.pdf herein incorporated by reference in its entirety.

For purposes of the present disclosure, the term “thermosetting powder” refers to a powder that when applied and subjected to heat will melt, flow and chemically crosslink to form a film coating on a substrate. Thermosetting powders are primarily composed of relatively high molecular weight solid resins and a crosslinker. The primary resins used in the formulation of a thermosetting powder are: epoxy, polyester and acrylic. These primary resins may be used with different crosslinkers to produce a variety of powder coatings.

For purposes of the present disclosure, the term “thermoset powder coating” refers to a film coating formed by melting, flowing and chemically crosslinking a thermosetting powder. Chemical reactions during the curing cycle of a thermoset powder coating create a polymer network which may provide resistance to coating breakdown. Once cured and crosslinked, this polymer network will not melt and flow again if heat is applied.

For purposes of the present disclosure, the term “water insoluble” refers to a substance that has a solubility of less than 0.1 g per 100 ml of water.

### Description

Because material surfaces may become contaminated with disease-causing agents, there is a need for materials with anti-bacterial, anti-virus, anti-fungal, anti-mold, etc. functionality; these are generally referred to as antimicrobials. Polymeric materials made from organic materials, inorganic materials or organic-inorganic material blends are ubiquitous in the environment, and if made to reduce antimicrobial disease-causing agents would play a valuable role in producing a healthier environment.

Three general classes of art for producing antimicrobial bulk polymers and polymer surfaces using additive systems currently exist: (1) nanoscale metal particles, (2) metal aluminosilicates, and (3) organic compounds. Although this art has demonstrated some utility it suffers from several limitations of which the following are the most often cited:

(1) wears out due to repeated handling, washing or scrubbing of surface applied materials,

(2) renders the bulk material not recyclable,

(3) does not confer significant antimicrobial resistance,

(4) narrow range of effectiveness against microbial agents,

(5) is toxic to viruses and molds with potential toxicity to humans at the levels employed,

(6) modification required of existing plastic product manufacturing, equipment or processes,

(7) post-production steps required for surface coating,

(8) incomplete coverage/coating due to “hidden” surfaces,

(9) is incompatible with critical geometries, such as products having micro-scale tolerances or dimensions.

In addition to the above-mentioned limitations of the existing art, the current products employing metal and aluminosilicate antimicrobial additives: (a) are costly, (b) have final product process-related issues such as reduced time-to-fabrication tooling wear out, therefore requiring more frequent tool replacement, and (c) require novel chemical moieties as surface ligands to help disperse and keep the particles from settling or agglomerating. Furthermore, current products employ organic antimicrobial additives that cannot be readily incorporated with many organic materials since these antimicrobial additives are: (a) chemically aggressive and inhibit the reaction processes of many thermosets and (b) degrade the mechanical, thermal and optical properties of many thermoplastics and thermosets.

An example of existing art appears in United States Patent Application No. 2011/0002872 A1 to Ohashi et al., but this patent application does not describe the final form of the product that integrates the disclosed antimicrobial invention, but instead describes a conversion process (e.g., thermal decomposition) of a fatty acid metal salt for forming ultrafine metal particles that can be dispersed in a polymer resin for further processing. As disclosed by Ohashi et al., Stearates obtained in Examples 1 to 10 and Comparative Examples 1 to 4 were added each in an amount of 0.5% by weight to a low-density polyethylene (manufactured by Sumitomo Kagaku Co.) which was then heat-melted in a biaxial extruder (manufactured by Toyo Seiki Co.) set at a temperature of 250° C., extruded through a T-die film-forming machine (manufactured by Toyo Seiki Co.), and was wound on a take-up roll. Thus, films containing fatty acid metal salts and having a thickness of 50 μm were obtained. Ohashi et al., therefore, utilizes greater temperatures (250° C. (482° F.)) than those employed by the present disclosure, and hence, decomposes the fatty acid metal salts (i.e., metal organoate).

Another example of existing art appears in United States Patent Application No. 2011/0003924 A1 to Ohashi et al., but this patent application does not describe the final form of the product that integrates the disclosed antimicrobial invention, but instead describes a conversion process (e.g., thermal decomposition) of a fatty acid metal salt for forming ultrafine metal particles that can be dispersed in a polymer resin for further processing. As disclosed by Ohashi et al., the heating conditions necessary for preparing the master batch vary depending upon the metal organoate that is used, and cannot be definitely defined. Usually, however, the heating is conducted at a temperature of 130 to 220° C. and, particularly, 140 to 200° C. for 1 to 1800 seconds and, particularly, 5 to 300 seconds. Thus, Ohashi et al. intends to also decompose the metal organoate, contrary to the disclosed invention.

Yet, another example of existing art appears in United States Patent Application No. 2014/0205644 A1 to Nieminen et al., but this patent application does not describe the final form of the product that integrates the disclosed antimicrobial invention, but instead describes antimicrobial expandable polystyrene (EPS) beads, comprising as main antimicrobial agent metal ions selected from silver and copper and combinations thereof. The plastic beads of Nieminen et al. may be coated with antimicrobial materials when they are dried. The antimicrobial materials, however, are not blended into the thermoplastic polymers.

Thus, prior art technology while providing metal particles to thermoplastics does so at the expense of forming the same under high temperature conditions. A concern, therefore, exists that such high temperature conditions cause thermal degradation of the thermoplastics during processing. Embodiments of the present disclosure provide improvements for making antimicrobial thermoplastic materials which does not require high temperatures and, therefore, prevents thermal degradation from occurring.

In one embodiment, the present disclosure provides a polymer product comprising a polymer host matrix having dispersed therein at least one antimicrobial organometallic additive or a blend of antimicrobial organometallic additives that impart antimicrobial properties to the bulk and surface of the polymer host matrix.

In one embodiment, the present disclosure provides uniformly dispersed antimicrobial functionality in a variety of host matrix polymer materials and a broad range of form factors. For example, the dispersed antimicrobial organometallic additives may be used to impart antimicrobial properties to the bulk and surface of a polymer host matrix in the form of bulk polymer products, film polymer products, sheet polymer products, polymer coating products, coated polymer products, composite polymer products, fibrous polymer products, a rod polymer products, core-containing polymer products and other types of polymer products.

In one embodiment, the present disclosure provides a polymer product comprising a polymer host matrix having dispersed therein at least one distributed metal type of antimicrobial organometallic additive or a blend of antimicrobial organometallic additives of more than one type of metal, said antimicrobial organometallic additives imparting antimicrobial properties to the bulk polymer products, film polymer products, sheet polymer products, polymer coating products, coated polymer products, composite polymer products, fibrous polymer products, a rod polymer products, core-containing polymer products and other types of polymer products.

In one embodiment of the present disclosure, the antimicrobial organometallic additive is about 0.008% to about 10% by volume of the total volume of the mixture of the antimicrobial organometallic additive in the polymer host matrix. In one embodiment of the present disclosure, the antimicrobial organometallic additive is about 0.008% to about 2.5% by volume of the total volume of the mixture of the antimicrobial organometallic additive in the polymer host matrix. In one embodiment of the present disclosure, the antimicrobial organometallic additive is about 0.008% to about 2% by volume of the total volume of the mixture of the antimicrobial organometallic additive in the polymer host matrix.

In one embodiment of the present disclosure, the blend of the antimicrobial organometallic additive is about 0.008% to about 3% by volume of the total volume of the mixture of the antimicrobial organometallic additive in the polymer host matrix. In one embodiment of the present disclosure, the blend of the antimicrobial organometallic additive is about 0.008% to about 2.5% by volume of the total volume of the mixture of the antimicrobial organometallic additive in the polymer host matrix. In one embodiment of the present disclosure, the blend of the antimicrobial organometallic additive is about 0.008% to about 2% by volume of the total volume of the mixture of the antimicrobial organometallic additive in the polymer host matrix.

In one embodiment, the present disclosure provides the ability to integrate one or more antimicrobial organometallic additives comprised of metals that are compatible with a variety of host matrix polymer materials that can be processed using conventional manufacturing equipment to fabricate various types of polymer products. In one embodiment of the present disclosure, the antimicrobial organometallic additives form a solid solution with the polymer host matrix and are distributed homogeneously throughout the polymer. Furthermore, the polymer host matrix may be an organic material, an inorganic material (e.g., silicone, etc.) or an organic-inorganic material blend. Also, the polymer host matrix may demonstrate the physical properties of a solid material, a liquid material, or a material having both solid-like and liquid-like physical properties.

In one embodiment of the present disclosure, an antimicrobial organometallic additive is an organic chemical moiety chemically bonded to a metal, either covalently or ionically. The chemical structure provides for enhanced miscibility throughout the polymer host matrix to produce various types of polymer products. Organic chemical moieties that may be bound to a metal in an antimicrobial organometallic additive of the present disclosure include but are not limited to the following chemical moieties: hydrocarbons, acetates, stearates, laureates, palmitates, oleates, abietates, fatty acids, etc.

Metals that may be used in the antimicrobial organometallic additives of the present disclosure include, but are not limited to, copper (Cu), silver (Ag), gold (Au), iridium (Ir), palladium (Pd), platinum (Pt), iron (Fe), nickel (Ni), cobalt (Co), zinc (Zn), niobium (Nb), ruthenium (Ru), rhodium (Rh), tellurium (Te), antimony (Sb), bismuth (Bi), tin (Sn), gallium (Ga), indium (In), titanium (Ti), vanadium (V), chromium, (Cr), manganese (Mn), molybdenum (Mo), tungsten (W), tantalum (Ta), hafnium (Hf), zirconium (Zr), scandium (Sc), and yttrium (Y), aluminum (Al), cadmium (Cd), mercury (Hg), thalium (Tl), lead (Pb), selenium (Se).

Metals that may be used in the antimicrobial organometallic additives of the present disclosure include alkali metals and alkali earth metals including, but are not limited to lithium (Li), sodium (Na), potassium (K), rubidium (Rb) cesium (Cs), beryllium (Be), magnesium (Mg), calcium (Ca), strontium (Sr), and barium (Ba).

Metals for the antimicrobial organometallic additives may be selected based on required functionality (e.g., anti-bacterial, anti-virus, anti-fungal, anti-mold, etc.) and may be chosen from the categories of transition metals, post-transition metals, metalloids, lanthanides, actinides, rare earth metals, alkaline earth metals, and alkali metals.

Suitable polymers that may be used in the polymer host matrix of the polymer products of the present disclosure include thermoplastics and thermosets and mixtures thereof.

In one embodiment of the present disclosure, the polymer host matrix may comprise a thermoplastic such as polyethylene (PE), polypropylene (PP), polycarbonate (PC), polystyrene (PS), polyamide (PA), polybutylene terephthalate (PBT), polyethylene terephthalate (PET), poly(methyl methacrylate), wax (e.g., paraffin, etc.), etc. In one embodiment, the polymer host matrix polymer may be a blend comprising more than one thermoplastic.

In one embodiment of the present disclosure, the polymer host matrix may comprise a thermoset plastic such as an epoxy, a phenolic, a cyanate ester, a bismaleimide, a polyimide, an acrylic, a silicone, a urethane, a latex, etc. In one embodiment, the polymer host matrix polymer may be a blend comprising more than one thermoset.

In one embodiment of the present disclosure, the polymer host matrix may comprise a polyurethane. The polymer host matrix may be a one-part polyurethane liquid polymer or a two-part polyurethane liquid polymer. The polyurethane polymer host matrix may be air cured, thermally cured, or UV-radiation cured.

In one embodiment of the present disclosure, the polymer host matrix may comprise a stable dispersion (emulsion) of polymer microparticles in an aqueous medium such as, but not limited to natural and synthetic latexes. The polymer host matrix may be a single polymer, a polymer blend, a co-polymer, or a co-polymer blend.

In one embodiment of the present disclosure, the polymer host matrix may comprise a mixture of a polymer and other materials such as glass. For example, the host matrix may be fiberglass which is a plastic matrix reinforced with fine glass fibers.

In various embodiments of the present disclosure, the polymer host matrix of the present disclosure may be formulated to achieve specific materials properties e.g., optical (clarity, refractive index, color, transparency, etc.), mechanical (elongation, glass transition temperature, coefficient of thermal expansion, elastic and shear modulus, toughness, adhesion, surface roughness, etc.), rheological (viscosity, melt flow index, surface energy, etc.), electrical (dielectric strength) and antimicrobial efficacy as required for optimal end product performance.

During thermal processing of the polymer host matrix and the antimicrobial organometallic additive, the antimicrobial organometallic additive may be converted to an organometallic-oxide.

In one embodiment, the present disclosure may be used as a bulk polymer product. In one embodiment, the present disclosure may be used as a polymer film. In one embodiment, the present disclosure may be used as a polymer sheet.

Bulk polymer products such as but not limited to master blends, toys, electronic housings, automotive interior panels, airplane passenger compartment structures, dental appliances such as mouth protectors, mouth guards, dentures and retainers, corrective vision devices (contact lenses, contact lens storage containers, eye glass frames), windows, aquarium walls, soap dispensers, paper towel dispensers, toilet paper dispensers, portable toilets, and portable washing stations. In these products, the host matrix bulk polymer provides substantial structural integrity for the device or application.

Film polymer products include but are not limited to flexible wrapping agents, film coats, and laminates. These products may have surface treatments to provide static or chemical adhesion as commonly used for promotional advertising, and marketing posters and labels. Film materials may be used in combination with touch screens and displays. Another example of a film polymer product is currency (banknotes). Furthermore, the film may be transparent, contain graphic art, text, or a combination of these. In these products, the film polymer provides little structural integrity to the device, but acts as a barrier or as a carrier of graphic information. In one embodiment, the film material is less than 0.1 mm thick.

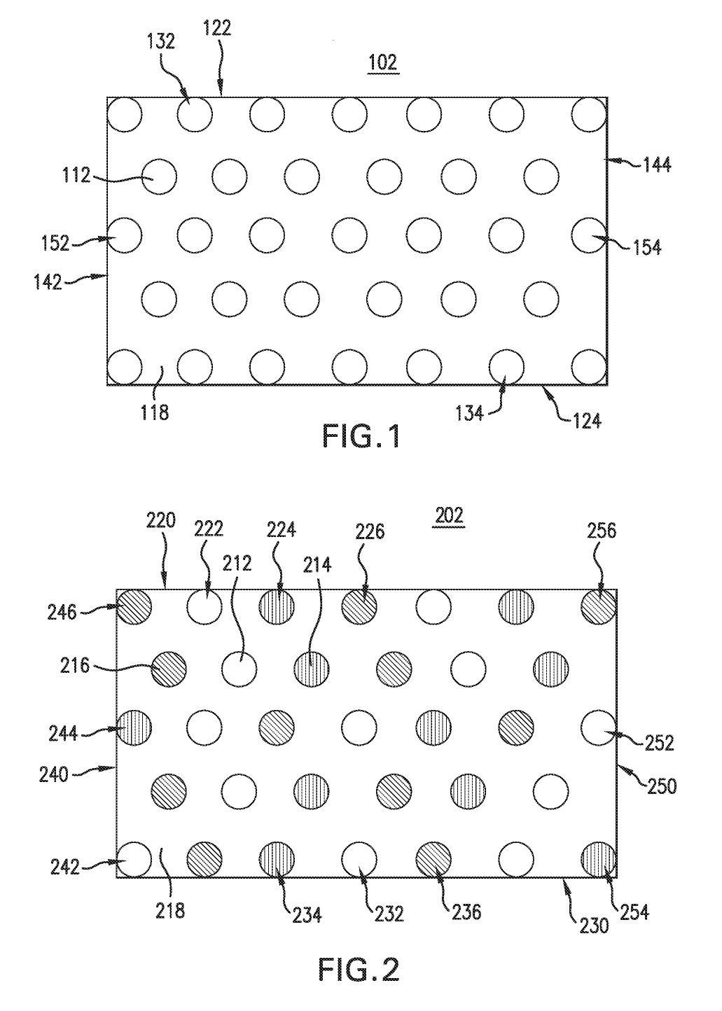

FIGS. 1 and 2 illustrate in schematic form polymer products that each may be a bulk polymer product, a film polymer product or a sheet polymer product, depending on factors such as the dimensions of the polymer product, the polymer host matrix used, the physical properties of the polymer product, etc.

FIG. 1 depicts a polymer product 102 having dispersed therein an antimicrobial organometallic additive 112 distributed uniformly throughout a polymer host matrix 118. Some antimicrobial organometallic additive 112 resides at an upper surface 122 and a lower surface 124, as indicated by additive 132 and 134, respectively. Some antimicrobial organometallic additive 112 resides at a left surface 142 and a right surface 144, as indicated by additive 152 and 154, respectively.

FIG. 2 depicts a polymer product 202 having dispersed therein antimicrobial organometallic additives 212, 214, 216 distributed uniformly throughout a polymer host matrix 218. Antimicrobial organometallic additives 212, 214, 216 are different from each other. Some antimicrobial organometallic additives 212, 214 and 216 reside at an upper surface 220 as indicated by additive 222, 224 and 226, respectively. Some antimicrobial organometallic additives 212, 214 and 216 reside at a lower surface 230 as indicated by additive 232, 234 and 236, respectively. Some antimicrobial organometallic additives 212, 214 and 216 reside at a left surface 240 as indicated by additive 242, 244 and 246, respectively. Some antimicrobial organometallic additives 212, 214 and 216 reside at a right surface 250 as indicated by additive 252, 254 and 256, respectively.

Although one antimicrobial organometallic additive is shown in FIG. 1 and three different antimicrobial organometallic additives are shows in FIG. 2, a polymer product of the present disclosure may include any number of different antimicrobial organometallic additives. The metal part of each of the antimicrobial organometallic additives may be the same or different and/or the organic part of each of the antimicrobial organometallic additives may be the same or different.

The polymer product of FIG. 1 and/or FIG. 2 may have virtually any size or shape. For example, polymer products of FIG. 1 and/or FIG. 2 may be a block of material, a film, a sheet, etc.

A polymer product of the present disclosure that is a block of material may be made in various shapes such as spherical, rectangular box-shaped, cube-shaped, ellipsoid-shaped, cone-shaped, pyramidal, rod-shaped, ring-shaped, disks, rectangular plate-shaped, irregularly shaped, etc. A spherical or nearly spherical polymer product may be used in balls for purifying liquids such as but not limited to water and water-based fruit juices and forming master batches for draw-down during manufacture of the final polymer product. A spherical or nearly spherical polymer product may be fabricated with different densities so that polymer product may float at different levels in a liquid environment.

In one embodiment, the polymer product of FIG. 1 and/or FIG. 2 may be a bulk polymer product that is at least 0.01 mm thick.

In one embodiment, the polymer product of FIG. 1 and/or FIG. 2 may be a film polymer product having a thickness of less than or equal to 1.0 mm.

In one embodiment, the polymer product of FIG. 1 and/or FIG. 2 may be a bulk product or a sheet. For example, the polymer product may be a bulk or sheet product used separately or in combination with items such as but not limited to mass transit windows, building windows, and aquarium walls. These sheet products may have surface treatments to provide static or chemical adhesion to an underlying transparent material such as but not limited to glass, polycarbonate, acrylics and poly(methyl methacrylate). In these products, the sheet polymer provides limited structural integrity to the device and acts as a barrier. Examples of a film polymer product used separately are bags (e.g., food, waste management), privacy curtains (hospital rooms, examining rooms, etc.) and gloves (e.g., hygiene, contamination protection). Furthermore, the sheet may be transparent, contain graphic art, text, or a combination of both. In one embodiment of the present disclosure, the sheet polymer product is greater than 0.01 mm and less than or equal to 10 mm thick.

In one embodiment the present disclosure provides polymer coatings comprising one or more antimicrobial organometallic additives uniformly dispersed in a polymer material. Such coatings may have a variety of uses such as for powder coats, paints, shrink wraps, films, etc. In polymer coatings, the polymer coating may act as a surface protector and barrier. The polymer coatings of the present disclosure may be used on a variety of substrates such as carts, hospital gurneys, desks, chairs, metal gratings, shelving (e.g., refrigerator, produce, dairy, candy, and health care products), filters, and corrugated metal such as used for architectural wall finishing, etc. Polymer coatings of the present disclosure may also be coated on substrates such as gratings, animal cages, livestock fencing, animal feeding containers (bowls, troughs, plates, dispensers), filters, architectural wall finishing, privacy walls in bathrooms, hand dryers, hand rails and escalator guard rails). A polymer coating of the present disclosure may be transparent, translucent or opaque and may be colored with dyes (e.g., organic polymers, inorganic suspensions). A polymer coating host matrix that is transparent has a refractive index of at least 1.1 at 633 nm with optical transmission of >90% from 375 to 600 nm. In one embodiment of the present disclosure, a coating may be less than 1 mm thick.

A polymer coating of the present disclosure may be formed by mixing one or more antimicrobial organometallic additive in powder form with a polymer host matrix material in powder form, such as a thermosetting powder, to form a mixture in which the one or more antimicrobial organometallic additives are dispersed throughout the mixture. The mixture may then be heated to melt the mixture and form a polymer coating product in which the one or more antimicrobial organometallic additives are suspended in the polymer host. The coating product may be heated in place on the substrate to form a coating or the coating product may be heated and then applied to the substrate as a coating.

A polymer coating of the present disclosure may be formed by mixing one or more antimicrobial organometallic additive in powder form with a polymer host matrix material in liquid form to form a mixture in which the one or more antimicrobial organometallic additives are dispersed throughout the liquid. The liquid mixture may then be applied to a substrate to form a polymer coating product in which the one or more antimicrobial organometallic additives are suspended in the polymer host. The coating product may be heated in place on the substrate to form a coating, polymerized on the substrate using ultraviolet radiation (UV) to form a coating, dried via evaporation of solvent to form a coating, polymerized on the substrate via chemical reactions (i.e., curing) to form a coating . Examples of polymer host materials are latex paints, oil-based paints, 1-part polyurethane, 2-part polyurethane, 1-part epoxy, 2-part epoxy, etc.

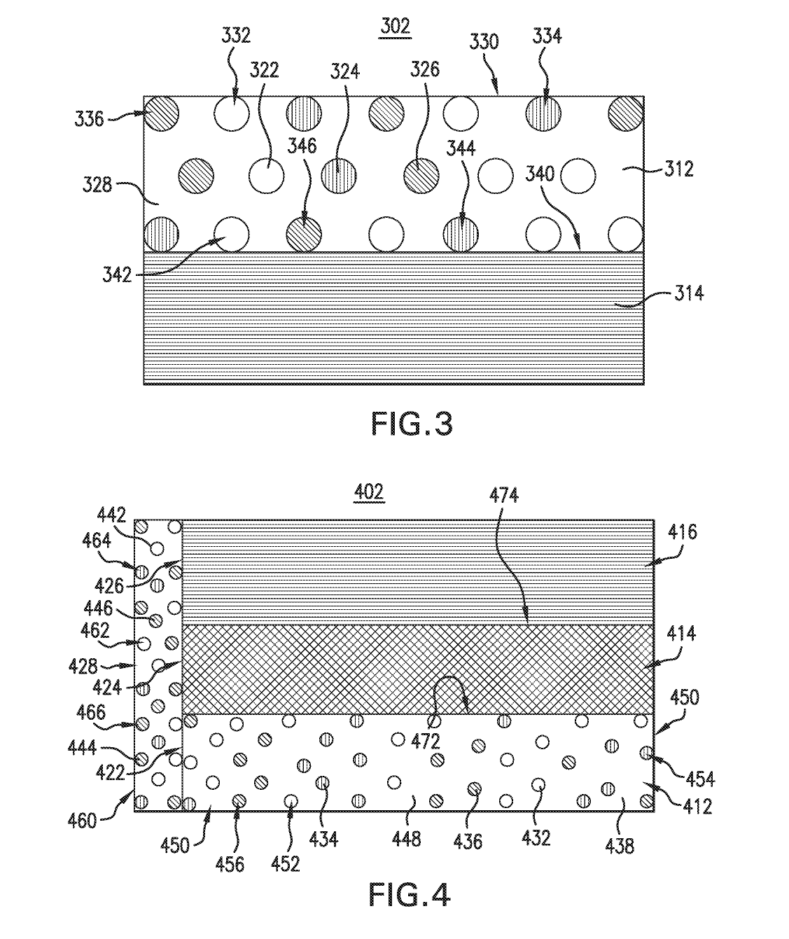

FIG. 3 shows a polymer coated substrate 302 according to one embodiment of the present disclosure. Polymer coated substrate 302 comprises a polymer coating 312 coated on a substrate 314. Polymer coating 312 contains a blend of three different antimicrobial organometallic additives, i.e., antimicrobial organometallic additives 322, 324 and 326, dispersed uniformly throughout a polymer host matrix 328 of polymer coating 312. Antimicrobial organometallic additives 322, 324 and 326 are present at a surface 330 of polymer coating 312, as shown by additives 332, 334 and 336, respectively, and at an interface 340 between polymer coating 312 and substrate 314, as shown by additive 342, 344 and 346, respectively. Polymer coating 312 is chemically and/or mechanically bonded to the substrate 314 at interface 340.

Although three antimicrobial organometallic additives are shown in the polymer coating of FIG. 3, there may be one, two, three, four or more antimicrobial organometallic additives in a polymer coating of the present disclosure. The antimicrobial organometallic additives may be of the same chemistry or they may be of different chemistries.

The substrate on which a polymer coating of the present disclosure is coated may be a metal such as aluminum, titanium, copper, brass, bronze, nickel, pewter, silver, gold, stainless steel, carbon steel, steel, molybdenum, Inconel, alloys of these metals, etc., a ceramic such as aluminum oxide (sapphire), ceramic tile, glass (borosilicate, soda-lime-silicate, quartz), granite, marble, etc., a plastic such as a vinyl polymer, polycarbonate, polyethylene, polypropylene, PEN, PET, poly(methyl methacrylate), wax (paraffin) etc, or any other type of suitable substrate material.

In one embodiment, the present disclosure provides a composite product including one or more antimicrobial organometallic additives in a polymer host matrix. Such composite products include fabrics, bandages, tents, mats (e.g., wrestling, gymnastics, bathroom), tarps, clothing used by first responders, clothing used by campers, clothing used for recreational purposes, work clothing, sports clothing, uniforms, space suits, military operations personnel, healthcare professionals, and hospital staff (e.g., surgical garments), etc. In a composite product of the present disclosure, a discrete layer or film comprising the one or more antimicrobial organometallic additives in a polymer host matrix is integrated into the composite product. A polymer layer comprising one or more antimicrobial organometallic additives in a polymer host matrix acts as a surface protector and barrier. The barrier functionality of such a polymer layer may include transmission of liquid such as water, and gases such as water vapor and air. In one embodiment, such a polymer layer is less than 1 mm thick.

FIG. 4 shows a composite product 402 according to one embodiment of the present disclosure. Composite product 402 includes a polymer layer 412, an inner layer 414 and an outer layer 416. Coated on edges 422, 424 and 426, respectively, of polymer layer 412, inner layer 414 and outer layer 416 is an edge coating 428. Polymer layer 412 comprises a blend of three different antimicrobial organometallic additives, i.e., antimicrobial organometallic additives 432, 434 and 436, dispersed uniformly throughout a polymer host matrix 438. Edge coating 428 comprises a blend of three different antimicrobial organometallic additives, i.e., antimicrobial organometallic additives 442, 444 and 446, dispersed uniformly throughout a polymer host matrix 448. Antimicrobial organometallic additives 432, 434 and 436 are also present at exterior surfaces 450 of polymer host matrix 438 as shown by arrows 452, 454 and 456, respectively. Antimicrobial organometallic additives 442, 444 and 446 are present at exterior surface 460 of polymer host matrix 448 as shown by arrows 462, 464 and 466. An interface 472 provides mechanical and/or chemical bonding between polymer layer 412 and inner layer 414. An interface 474 provides mechanical and/or chemical bonding between inner layer 414 and outer layer 416.

Although the edge coating in FIG. 4 is shown as covering the edges of the polymer layer, the inner layer and the outer layer, in some embodiments of the present disclosure, the edges of only one or two of these layers may be coated with the edge coating.

Although in FIG. 4, an edge coating is only shown on the left-hand side of the composite product, in some embodiments of the present disclosure, there may be an edge-coating on both the left-hand and right-hand side of the composite product. The edge coatings on each side may be the same or different.

Although three antimicrobial organometallic additives are shown in the polymer layer and the edge coating of FIG. 4, there may be one, two, three, four or more antimicrobial organometallic additives in an edge coating or polymer layer of a composite product of the present disclosure. The antimicrobial organometallic additive may be the same chemistry or different chemistry.

The polymer host matrix and the antimicrobial organometallic additives of the polymer layer and the edge coating may be the same or different.

In one embodiment of the present disclosure, the polymer layer of a composite product may have a thickness of 10 mm or less.

In one embodiment of the present disclosure the outer layer and inner layer of the composite product may be porous to allow transmission of liquids such as water, and gases such as water vapor and air to the polymer layer.

The inner and outer layers may be made from a variety of materials including woven or non-woven textiles such as silk, cotton, polymer textiles or blends thereof, high strength plastics such as but not limited to poly-paraphenylene terephthalamide (e.g., Kevlar®), and metals such as but not limited to aluminum, titanium, copper, brass, bronze, nickel, pewter, silver, gold, stainless steel, carbon steel, steel, molybdenum, Inconel, alloys of these metals, etc., a ceramic such as aluminum oxide (sapphire), ceramic tile, glass (borosilicate, soda-lime-silicate, quartz), granite, marble, etc., a plastic such as a vinyl polymer, polycarbonate, polyethylene, polypropylene, PEN, PET, poly(methyl methacrylate), wax (paraffin) etc., or any other type of suitable substrate material.

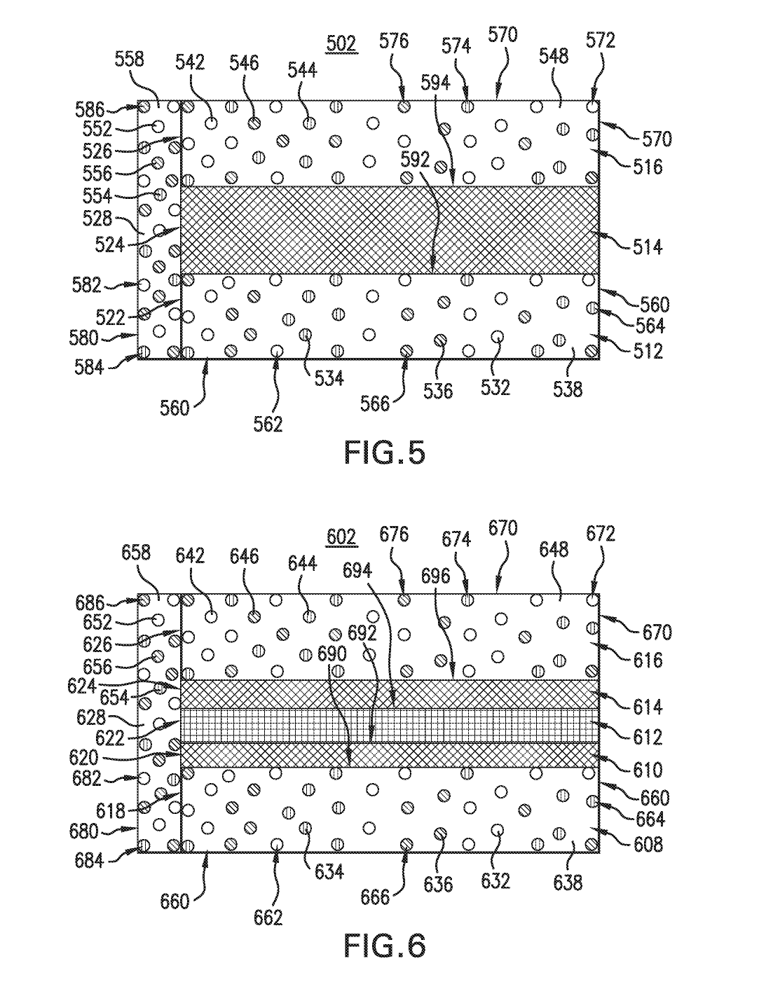

FIG. 5 shows a composite product 502 according to one embodiment of the present disclosure. Composite product 502 includes a lower polymer layer 512, an inner layer 514 and an upper polymer layer 516. Coated on edges 522, 524 and 526, respectively, of lower polymer layer 512, inner layer 514 and upper polymer layer 516 is an edge coating 528. Lower polymer layer 512 comprises a blend of three different antimicrobial organometallic additives, i.e., antimicrobial organometallic additives 532, 534 and 536, dispersed uniformly throughout a polymer host matrix 538. Upper polymer layer 516 comprises a blend of three different antimicrobial organometallic additives, i.e., antimicrobial organometallic additives 542, 544 and 546, dispersed uniformly throughout a polymer host matrix 548. Edge coating 528 comprises a blend of three different antimicrobial organometallic additives, i.e., antimicrobial organometallic additives 552, 554 and 556, dispersed uniformly throughout a polymer host matrix 558. Antimicrobial organometallic additives 532, 534 and 536 are present at exterior surfaces 560 of polymer host matrix 538 as shown by additive 562, 564 and 566, respectively. Antimicrobial organometallic additives 542, 544 and 546 are present at exterior surfaces 570 of polymer host matrix 548 as shown by additive 572, 574 and 576, respectively. Antimicrobial organometallic additives 552, 554 and 556 are present at exterior surface 580 of polymer host matrix 548 as shown by additive 582, 584 and 586. An interface 592 provides mechanical and/or chemical bonding between lower polymer layer 512 and inner layer 514. An interface 594 provides mechanical and/or chemical bonding between inner layer 514 and upper polymer layer 516.

Although the edge coating in FIG. 5 is shown as covering the edges of the lower polymer layer, the inner layer and the upper polymer layer, in some embodiments of the present disclosure, the edges of only one or two of these layers may be coated with the edge coating.

Although in FIG. 5, an edge coating is only shown on the left-hand side of the composite product, in some embodiments of the present disclosure, there may be an edge-coating on both the left-hand and right-hand side of the composite product. The edge coatings on each side may be the same or different.

Although three antimicrobial organometallic additives are shown in the lower polymer layer, upper polymer layer and the edge coating of FIG. 5, there may be one, two, three, four or more antimicrobial organometallic additives in an edge coating or polymer layer of a composite product of the present disclosure. The antimicrobial organometallic additive may be the same chemistry or different chemistry.

The polymer host matrix and the antimicrobial organometallic additives of the lower polymer layer, upper polymer layer and the edge coating may be the same or different for each of the lower polymer layer upper polymer layer and the edge coating.

In one embodiment of the present disclosure, the lower polymer layer and/or upper polymer layer of a composite product may have a thickness of 1 mm or less.

In one embodiment of the present disclosure the inner layer of the composite product may be porous to allow transmission of liquids such as water, and gases such as water vapor and air to the polymer layer.

The inner layer may be made from a variety of materials including woven or non-woven textiles such as silk, cotton or blends thereof, high strength plastics such as but not limited to poly-paraphenylene terephthalamide (e.g., Kevlar®), and metals such as but not limited to aluminum, titanium, copper, brass, bronze, nickel, pewter, silver, gold, stainless steel, carbon steel, steel, molybdenum, Inconel, alloys of these metals, etc., a ceramic such as aluminum oxide (sapphire), ceramic tile, glass (borosilicate, soda-lime-silicate, quartz), granite, marble, etc., a plastic such as a vinyl polymer, polycarbonate, polyethylene, polypropylene, PEN, PET, poly(methyl methacrylate), wax (paraffin) etc., or any other type of suitable substrate material.

FIG. 6 shows a composite product 602 according to one embodiment of the present disclosure. Composite product 602 includes a lower polymer layer 608, a lower inner layer 610, a middle inner layer 612, an upper inner layer 614 and an upper polymer layer 616. Coated on edges 618, 620, 622, 624 and 626, respectively, of lower polymer layer 608, lower inner layer 610, middle inner layer 612, upper inner layer 614 and upper polymer layer 616 is an edge coating 628. Lower polymer layer 608 comprises a blend of three different antimicrobial organometallic additives, i.e., antimicrobial organometallic additives 632, 634 and 636, dispersed uniformly throughout a polymer host matrix 638. Upper polymer layer 616 comprises a blend of three different antimicrobial organometallic additives, i.e., antimicrobial organometallic additives 642, 644 and 646, dispersed uniformly throughout a polymer host matrix 648. Edge coating 628 comprises a blend of three different antimicrobial organometallic additives, i.e., antimicrobial organometallic additives 652, 654 and 656, dispersed uniformly throughout a polymer host matrix 658. Antimicrobial organometallic additives 632, 634 and 636 are present at exterior surfaces 660 of polymer host matrix 638 as shown by additives 662, 664 and 666, respectively. Antimicrobial organometallic additives 642, 644 and 646 are present at exterior surfaces 670 of polymer host matrix 648 as shown by additives 672, 674 and 676, respectively. Antimicrobial organometallic additives 652, 654 and 656 are present at exterior surface 680 of polymer host matrix 648 as shown by additives 682, 684 and 686. An interface 690 provides mechanical and/or chemical bonding between lower polymer layer 608 and lower inner layer 610. An interface 692 provides mechanical and/or chemical bonding between lower inner layer 610 and middle inner layer 612. An interface 694 provides mechanical and/or chemical bonding between middle inner layer 612 and upper inner layer 614. An interface 696 provides mechanical and/or chemical bonding between upper inner layer 614 and upper polymer layer 616.

Although the edge coating in FIG. 6 is shown as covering the edges of the lower polymer layer, the lower inner layer, the middle inner layer, the upper inner layer and the upper polymer layer, in some embodiments of the present disclosure, the edges of only one, two, three or four of these layers may be coated with the edge coating.

Although in FIG. 6, an edge coating is only shown on the left-hand side of the composite product, in some embodiments of the present disclosure, there may be an edge-coating on both the left-hand and right-hand side of the composite product. The edge coatings on each side may be the same or different.

Although three antimicrobial organometallic additives are shown in the lower polymer layer, upper polymer layer and the edge coating of FIG. 6, there may be one, two, three, four or more antimicrobial organometallic additives in an edge coating or polymer layer of a composite product of the present disclosure. The antimicrobial organometallic additive may be the same chemistry or different chemistry.

The polymer host matrix and the antimicrobial organometallic additives of the lower polymer layer, upper polymer layer and the edge coating may be the same or different for each of the lower polymer layer, upper polymer layer and the edge coating.

In one embodiment of the present disclosure, the lower polymer layer and/or upper polymer layer of a composite product may have a thickness of 1 mm or less.

In one embodiment of the present disclosure, the lower inner layer, middle inner layer and/or upper middle layer of the composite product may be porous to allow transmission of liquids such as water, and gases such as water vapor and air to the polymer layer.

The lower inner layer, middle inner layer and/or upper middle layer may each be made from a variety of materials including woven or non-woven textiles such as silk, cotton, polymer textiles or blends thereof, high strength plastics such as but not limited to poly-paraphenylene terephthalamide (e.g., Kevlar®), and metals such as but not limited to aluminum, titanium, copper, brass, bronze, nickel, pewter, silver, gold, stainless steel, carbon steel, steel, molybdenum, Inconel, alloys of these metals, etc., a ceramic such as aluminum oxide (sapphire), ceramic tile, glass (borosilicate, soda-lime-silicate, quartz, etc.), granite, marble, etc., a plastic such as a vinyl polymer, polycarbonate, polyethylene, polypropylene, PEN, PET, poly(methyl methacrylate), wax (paraffin) etc., or any other type of suitable substrate material.

In one embodiment, the present disclosure may be a fiber polymer product. Fiber polymer products of the present disclosure may be used in various types of products such as floor coverings (e.g., carpets, rugs, etc.), artificial turf (e.g., residential, athletic, landscaping, etc.), window shades and draperies, privacy curtains, wall coverings (e.g., wall paper), seating upholstery, air filters, water filters, thread, fabric, cloth, clothing, textiles, etc.

In one embodiment of the present disclosure, a fiber polymer product may have a diameter of 10 mm or less.

In one embodiment, the present disclosure may be a rod polymer product. Rod polymer products of the present disclosure may be used in such products as a guard rails, hand rails (e.g., for a banister, escalator), door handles, grab bars, shower rods, shopping cart handles, extruded products, facemasks for helmets, electrical wiring, etc. The rod form may be modified to form belts, or have multiple surfaces, detents, notches, flats, indents, etc.

In one embodiment of the present disclosure, a rod polymer product may have a diameter of 10 mm or greater.

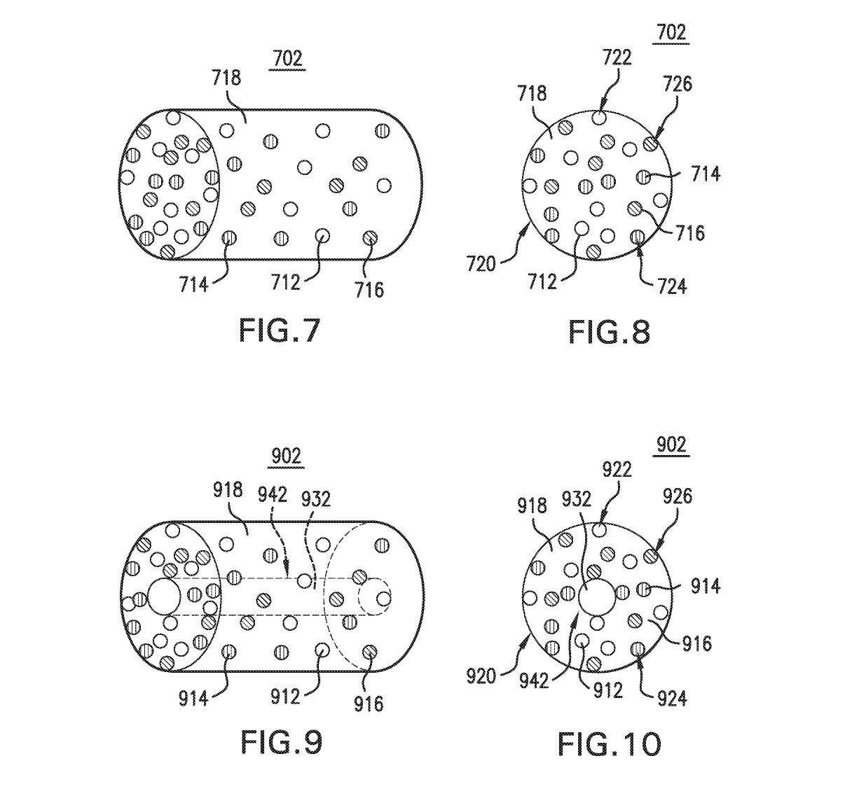

FIGS. 7 and 8 illustrate in schematic form an elongated polymer product having dispersed therein three antimicrobial organometallic additives according to one embodiment of the present disclosure. The elongated polymer product of FIGS. 7 and 8 may be a fiber polymer product or a rod-shaped polymer product, depending on factors such as the dimensions of the polymer product, the polymer host matrix used, the physical properties of the polymer product, etc.

FIGS. 7 and 8 depict an elongated polymer product 702 having dispersed therein antimicrobial organometallic additives 712, 714 and 716 distributed uniformly throughout a polymer host matrix 718. Antimicrobial organometallic additives 712, 714 and 716 are different from each other. Some antimicrobial organometallic additives 712, 714 and 716 reside at an outer surface 720 as indicated by additives 722, 724 and 726, respectively.

Although three antimicrobial organometallic additives are shown in the polymer product of FIGS. 7 and 8, there may be one, two, three, four or more antimicrobial organometallic additives in a fiber polymer product or a rod polymer product of the present disclosure. The organometallic additive may be of the same chemistry or different chemistry

Although the cross-sectional shape of the polymer product shown in FIGS. 7 and 8 is circular, a fiber polymer product or rod-shaped polymer product of the present disclosure may have any cross-sectional shape such as oval, triangular, square, rectangular, hexagonal, polygonal, I-shaped, U-shaped, star-shaped, asterix-shaped, multi-polygonal, multi-dimensional, etc.

In one embodiment, the present invention may be utilized in a reinforced fiber polymer product. Reinforced fiber polymer products of the present disclosure may be used in various types of products such as floor coverings (e.g., carpets, rugs), artificial turf (e.g., residential, athletic, landscaping), window shades and draperies, privacy curtains, wall coverings (e.g., wall paper), seating upholstery, air filters, water filters, electrical wiring, thread, fabric, cloth, clothing, textiles, etc.

In one embodiment of the present invention, a reinforced fiber polymer product may have a diameter of 10 mm or less.

In one embodiment, the present invention may be utilized in a rod polymer product. Rod polymer products of the present disclosure may be used in such product as a guard rails, hand rails (e.g., for a banister, escalator), door handles, grab bars, shower rods, shopping cart handles, extruded products, facemasks for helmets, electrical wiring, etc. The rod form may be modified to form belts, or have multiple surfaces, detents, notches, flats, indents, etc.

In one embodiment, a reinforced rod polymer product may have a diameter of 10 mm or greater.

FIGS. 9 and 10 illustrate in schematic form a reinforced polymer product having dispersed therein three antimicrobial organometallic additives according to one embodiment of the present disclosure. The reinforced polymer product of FIGS. 9 and 10 may be a reinforced fiber polymer product or a reinforced rod-shaped polymer product depending on factors such as the dimensions of the polymer product, the polymer host matrix used, the physical properties of the polymer product, etc.

FIGS. 9 and 10 depict a reinforced polymer product 902 having dispersed therein antimicrobial organometallic additives 912, 914 and 916 distributed uniformly throughout a polymer host matrix 918. Antimicrobial organometallic additives 912, 914 and 916 are different from each other. Some antimicrobial organometallic additives 912, 914 and 916 reside at an outer surface 920 as indicated by additives 922, 924 and 926, respectively. A support structure 932 runs through polymer product 902. An interface 942 provides mechanical and chemical bonding between the polymer host fiber matrix 918 and support structure 932.

Although three antimicrobial organometallic additives are shown in the reinforced polymer product of FIGS. 9 and 10, there may be one, two, three, four or more antimicrobial organometallic additives in a reinforced polymer product of the present disclosure. The antimicrobial organometallic additives may be the same chemistry or different chemistry.

Although the cross-sectional shape of the reinforced polymer product and support structure shown in FIGS. 9 and 10 is circular, a reinforced polymer product and/or support structure of the present disclosure may have any cross-sectional shape such as oval, triangular, square, rectangular, hexagonal, polygonal, I-shaped, U-shaped, star-shaped, asterix-shaped, multi-polygonal, multi-dimensional, etc. The reinforced polymer product and support structure may have the same or different cross-sectional shapes. The support structure may also be non-existent so that the resulting structure forms a hollow tube, pipe, or other structure with an opening substantially throughout its body.

The length of a support structure relative to a reinforced polymer product may be the same as the reinforced polymer product, shorter than the reinforced polymer product or longer than the reinforced polymer product. A reinforced polymer product may also include more than one support structure that may be arranged along the same axis in the reinforced polymer product and/or along different axes in the reinforced polymer product and/or scattered throughout the reinforced polymer product.

The support structure of a reinforced polymer product may form the bulk of a reinforced polymer product. The support structure of a reinforced polymer product may be made of various materials such as a metal, ceramic, a plastic material, etc. or combinations thereof, depending on the desired property of the reinforced polymer product.

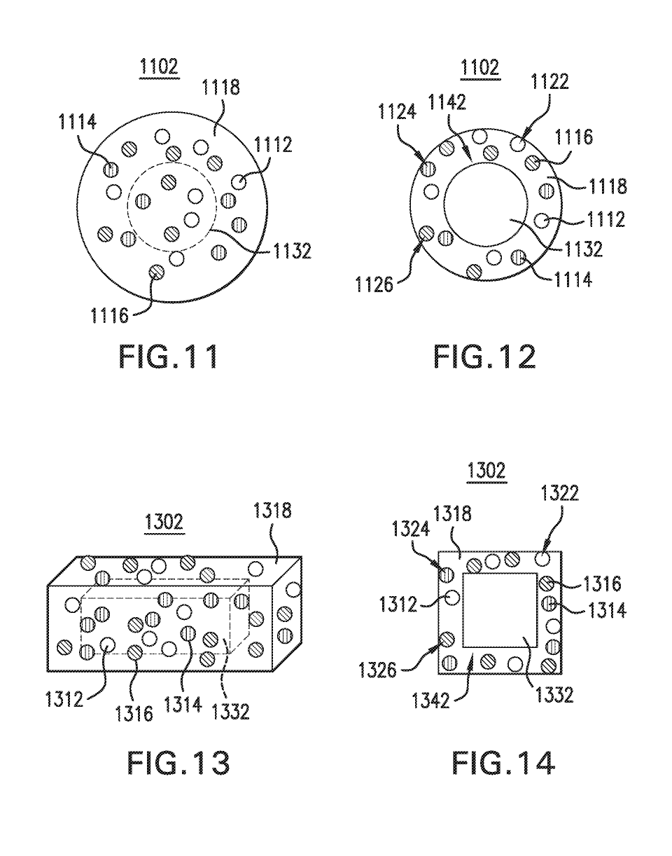

FIGS. 11, 12, 13 and 14 illustrate in schematic form two examples of core-containing polymer products of the present disclosure. FIGS. 11 and 12 illustrate a spherical-shaped core-containing polymer product having dispersed therein three antimicrobial organometallic additives according to one embodiment of the present disclosure. FIGS. 13 and 14 illustrate a rectangular box-shaped core-containing polymer product having dispersed therein three antimicrobial organometallic additives according to one embodiment of the present disclosure.

Spherical or nearly spherical products may be used in purifying liquids such as water, water-based fruit juices, etc. Pelletized polymer products used as the feedstock in the manufacture of final polymer products by thermal injection molding, extrusion, etc., can also have spherical or near spherical form. The spherical or nearly spherical products may be fabricated with different densities so that they may float at different levels in a liquid environment. Non-spherical shapes, such as but not limited to rods, rings, disks, rectangular plates, pyramidal and other geometries may also be used.

A polymer product of the present disclosure that is a core-containing polymer product may be made in various shapes such as spherical, rectangular box-shaped, cube-shaped, ellipsoid-shaped, cone-shaped, pyramidal, rod-shaped, ring-shaped, disks, rectangular plate-shaped, irregularly shaped, etc. A spherical or nearly spherical polymer product may be used in balls for purifying liquids such as but not limited to water, water-based liquids, water-based fruit juices, milk, etc. Pelletized polymer products used as the feedstock in the manufacture of final polymer products, for example, thermal injection molding, extrusion, etc., can also have spherical or near spherical form. A spherical or nearly spherical polymer product may be fabricated with different densities so that the polymer product may float at different levels in a liquid environment.

FIGS. 11 and 12 depict a spherical core-containing polymer product 1102 having dispersed therein antimicrobial organometallic additives 1112, 1114 and 1116 distributed uniformly throughout a polymer host matrix 1118. Antimicrobial organometallic additives 1112, 1114 and 1116 are different from each other. Some antimicrobial organometallic additives 1112, 1114 and 1116 reside at an outer surface 1120 as indicated by additives 1122, 1124 and 1126, respectively. A core 1132 is located inside polymer product 1102 and may also contain antimicrobial organometallic additives or not. An interface 1142 provides mechanical and chemical bonding between the polymer host matrix 1118 and core 1132.

FIGS. 13 and 14 depict a rectangular box-shaped core-containing polymer product 1302 having dispersed therein antimicrobial organometallic additives 1312, 1314 and 1316 distributed uniformly throughout a polymer host matrix 1318. Antimicrobial organometallic additives 1312, 1314 and 1316 are different from each other. Some antimicrobial organometallic additives 1312, 1314 and 1316 reside at an outer surface 1320 as indicated by additives 1322, 1324 and 1326, respectively. A core 1332 is located inside polymer product 1302 and may also contain antimicrobial organometallic additives or not. An interface 1342 provides mechanical and chemical bonding between the polymer host matrix 1318 and core 1332.

A core-containing polymer product of the present disclosure may have various shapes such as spherical or nearly spherical (as shown in FIGS. 11 and 12), rectangular box-shaped (as shown in FIGS. 13 and 14), cube-shaped, ellipsoid-shaped, cone-shaped, pyramidal, rod-shaped, ring-shaped, disks, rectangular plate-shaped, irregularly shaped, multi-polygonal, multi-dimensional, etc. A spherical or nearly spherical polymer product may be utilized as the core. Although three antimicrobial organometallic additives are shown in the core-containing polymer products of FIGS. 11, 12, 13 and 14 and there may be one, two, three, four or more antimicrobial organometallic additives in a reinforced polymer product of the present disclosure. The antimicrobial organometallic additive may be the same chemistry or different chemistry.

A core-containing polymer product of the present disclosure may have various shapes such as spherical or nearly spherical (as shown in FIGS. 11 and 12), rectangular box-shaped (as shown in FIGS. 13 and 14), cube-shaped, ellipsoid-shaped, cone-shaped, pyramidal, rod-shaped, ring-shaped, disks, rectangular plate-shaped, irregularly shaped, multi-polygonal, multi-dimensional, etc. A spherical or nearly spherical core-containing polymer product may be used in balls for purifying liquids such as but not limited to water, water-based liquids, water-based fruit juices, milk, etc. Pelletized polymer products used as the feedstock in the manufacture of final polymer products, for example, thermal injection molding, extrusion, etc., can also have spherical or near spherical form. A spherical or nearly spherical polymer may be fabricated with different densities so that they may float at different levels in a liquid environment.

The antimicrobial organometallic additive in any of the polymer products and/or any portion and/or layer of a polymer product of the present disclosure may be at various ratios with respect to each other. For example, when a blend of three antimicrobial organometallic additives are dispersed in a polymer host matrix of the present disclosure, the ratio of the antimicrobial organometallic additives may be 1:1:1, 1:2:1, 2:3:4, or any other suitable ratio.

In one embodiment, the antimicrobial organometallic additives are a majority of the metallic species present in a polymer host matrix of a polymer product of the present disclosure. In some embodiments of the present disclosure there may be low levels of metals or metal ions present from other additives dispersed throughout the polymer host matrix (e.g., UV protectors, colorants, etc.). In some embodiments of the present disclosure, the antimicrobial organometallic additives may be the only metallic species present in a polymer host matrix of a polymer product of the present disclosure.

In one embodiment, the antimicrobial polymer products of the present disclosure include antimicrobial organometallic additives that are water insoluble or sparingly soluble in water. A single water insoluble or sparingly insoluble antimicrobial organometallic additive may be employed or mixtures of water insoluble and/or sparingly soluble antimicrobial organometallic additives may be employed. In one embodiment of the present disclosure, the water insoluble antimicrobial organometallic additives may comprise a long-chain fatty acid group as their organic component. Such compounds include, metal stearates and mixtures thereof. Suitable metal stearates that provide antimicrobial activity to a polymer product include, silver stearate, cupric stearate, zinc stearate, etc., and mixtures thereof. One advantage of using water insoluble antimicrobial organometallic additives having a long-chain fatty acid group as their organic component is that that they should provide long-lasting antimicrobial activity to polymer products, even when the polymer products are exposed to moisture or immersed in water. The water insolubility of such additives and the presence of the long-chain fatty acid group should cause such additives to stay bound and/or complexed in the polymer of the polymer product and not leach into the moisture or water. This is different than that for water soluble antimicrobial organometallic additives, for example, acetate based systems.

In one embodiment, the present disclosure provides a polyurethane product having antimicrobial activity that may be made by mixing one or more antimicrobial organometallic additives of the present disclosure with a liquid polyurethane at room temperature.

In one embodiment, the present disclosure provides a powder coat product, such as a thermoset powder coating. A thermoset powder coating may be formed by mixing one or more antimicrobial organometallic additives in powder form with a thermosetting powder to form a powder mixture. The powder mixture is then applied to a substrate and heated to melt, flow and chemically crosslink the components of the thermosetting powder in the powder mixture to form a thermoset film coating on the substrate. The thermoset coating has the one or more antimicrobial organometallic additives dispersed therein. The temperature that is used to form the thermoset film coating depends on the particular components of the thermosetting powder. In one embodiment, the temperature used to form the thermoset film coating is from 170° C. to 215° C.

In one embodiment of the present disclosure, the polymer host matrix may be paraffin wax. A paraffin wax product of the present may be formed by mixing one or more antimicrobial organometallic additives with liquid paraffin wax at temperature of 37° C. to 100° C. to form a paraffin wax product having the one or more antimicrobial organometallic additives dispersed throughout the polymer host matrix.

Thermoplastic materials can be formed by several related processes. Commercially available processes to make thermoplastic products may include thermal injection molding (TIM), polymer extrusion , and polymer pelletizing¹. Antimicrobial organometallic additives, such as copper stearate (CuST), zinc stearate (ZnST) or silver stearate (AgST), may be added to the thermoplastic polymer individually or as blends to produce thermoplastic materials that have antimicrobial functionality.

Processing temperatures for the thermoplastic host materials of the disclosed invention may vary by the host resin. In order to prevent CuST, ZnST, or AgST utilized by the invention from decomposing, the mixing chambers in the processing equipment must be held below the decomposition temperatures of any antimicrobial organometallic additives (which is about 200° C. (392° F.)). Accordingly, for ZnST, the melting point is about 118° C.-128° C. (244° F.-262° F.) and the decomposition temperature is greater than about 200° C. (392° F.). For CuST, the melting point is about 124° C.-125° C. (255° F.-257° F.) and the decomposition temperature is greater than about 200° C. (392° F.). For AgSt, the melting point is about 205° C. (401° F.) and the decomposition temperature is greater than melting point. Disclosed embodiments will avoid the aforementioned decomposition temperature ranges of any antimicrobial organometallic additives, such as for CuST or ZnST, added to the thermoplastic polymer individually or as blends to produce thermoplastic materials that have antimicrobial functionality.

The pressure ranges of the disclosed thermoplastic host materials and antimicrobial organometallic additives are machine dependent and should be optimized for each machine and resin.

Thermal injection molding, polymer extrusion molding and polymer pelletizing operations have few if any environmental control limitations as applied to the disclosed invention. All may be operated in standard manufacturing environments with respect to temperature and humidity. Extra precautions may be taken for clean room processing, but such precautions are more dependent on keeping the disclosed thermoplastic host material product from being contaminated in some way, and not a limitation of the manufacturing equipment or processes. To this end operators may take precautions such as wearing gloves, head coverings and masks for their own protection and to prevent any polymer resins from being contaminated.

With respect to the process protocols of the disclosed invention, processing temperatures must be respected to prevent the polymer host material from burning (i.e. oxidizing) in the equipment. This is a function of maintaining the proper operating temperature and not exceeding the specific disclosed polymer's properties, which vary by polymer type as outlined below. Temperature control of the various heating/mixing and molding stages is important. If necessary, the disclosed resins may be dried to lower the water content prior to processing according to disclosed embodiments.

Exemplary disclosed embodiments may fabricate products with CuST and/or ZnST additives with one or more of the following noted resin materials and conditions. In some cases, commercial colorants may be added to the mixture. Accordingly, the following materials and conditions may be utilized to achieve the disclosed invention:
Polypropylene (PP) having a melt temperature of approximately 171° C.-204° C. (340° F.-400° F.);
Polyethylene (PE), low density polyethylene (LDPE) having a melting point of approximately 110° C. (230° F.) to 180° C. (356° F.), high density polyethylene (HDPE), having a melting point of approximately 105° C. (221° F. to 115 ° C. (239 ° F.), injection molding temperature of approximately 132° C.-205° C. (270° F.-400° F.);
Polyvinyl Chloride (PVC) , injection molding temperature of approximately 100° C.-260° C. (212° F.-500° F.);
Polyurethane (PU) and Thermoplastic Polyurethane (TPU): injection molding temperature of approximately 157° C.-199° C. (315° F.-390° F.);
Polystyrene (PS), injection molding temperature of approximately 210° C.-249° C. (410° F.-480° F.);
Acrylonitrile Butadiene Styrene (ABS), injection molding temperature of approximately 204° C.-238° C. (400° F.-460° F.).

According to select embodiments, fabricated products with CuST and/or ZnST additives may be excluded or limit the following materials and conditions from the disclosed invention:
Polycarbonate (PC): its relatively high processing temperature 288° C.-316° C. (550 ° F.-600° F.) causes the ZnST or CuST to breakdown resulting in crazing of the final product.
Polyester (PET or PETE): injection mold temperature 260° C. (500° F.). In some disclosed embodiments, however, polyester can be processed at lower temperatures, below about 400° F., and then it can be mixed with CuST or ZnST.

The present disclosure will now be described by way of example.

### EXAMPLES

The testing of antimicrobial activity for the polymer samples in Examples 1, 2, and 4 below is performed using the Microchem Laboratories JIS Z 2801 Test for Antimicrobial Activity of Plastics. A summary of the JIS Z 2801 Test procedure is provided below:

(1) The test microorganism is prepared, usually by growth in a liquid culture medium.

(2) The suspension of test microorganism is standardized by dilution in a nutritive broth (this affords microorganisms the potential to grow during the test).

(3) Control and test surfaces are inoculated with microorganisms, in triplicate, and then the microbial inoculum is covered with a thin, sterile film. Covering the inoculum spreads it, prevents it from evaporating, and ensures close contact with the antimicrobial surface.

(4) Microbial concentrations are determined at “time zero” by elution followed by dilution and plating.

(5) A control is run to verify that the neutralization/elution method effectively neutralizes the antimicrobial agent in the antimicrobial surface being tested.

(6) Inoculated, covered control and antimicrobial test surfaces are allowed to incubate undisturbed in a humid environment for 24 hours.

(7) After incubation, microbial concentrations are determined. Reduction of microorganisms relative to initial concentrations and the control surface is calculated.

The testing of antimicrobial activity for the polymer samples in Example 3 below is performed using the Antimicrobial Test Laboratories Microchem Laboratories AATCC100 Test for American Association of Textile Chemists and Colorists Method 100 Assessment of Antibacterial Finishes on Textile Materials. A summary of the AATCC100 Test procedure is provided below:

(1) Test microorganisms are prepared in liquid culture medium for bacteria or on agar for fungi.

(2) The suspension of test microorganism is standardized by dilution in a buffered saline solution.

(3) Test and control materials are cut into appropriately sized swatches and stacked. The number of swatches used per stack is that which is required to absorb the entire liquid inoculum.

(4) Control and test materials are inoculated with microorganisms and set to incubate in a humid environment at body temperature for the Sponsor-determined contact time.

(5) Microbial concentrations are determined at “time zero” by analysis of control materials immediately after inoculation.

(6) An additional control is implemented to verify neutralization effectiveness of the antimicrobial agent at the close of the study.

(7) After incubation, microbial concentrations are determined, and reductions of microorganisms are calculated relative to control materials are calculated.

### Example 1

High Density Polypropylene (HDPP) pellets are prepared by thermal injection molding². About eleven pounds of HDPP pellets are mixed with approximately 0.1 pounds (1%) of CuST powder, approximately 0.1 pounds (1%) of AgST powder and approximately 15 ml of mineral oil and stirred until the powders coat the pellets. It should be appreciated that these ratios may be altered by +/−10% and still be within the teachings of the invention. The coated pellets are introduced into the TIM. The TIM melt temperature is about 193° C. (380° F.) and the mold temperature is about 13° C. (55° F.). The TIM samples are collected and representative samples are sent to a third-party laboratory for antimicrobial testing. Using the JIS Z 2801 test protocol, the samples demonstrate about 99.999% reduction³ in E. coli.

### Example 2

High Density Polypropylene (HDPP) pellets are prepared by thermal injection molding⁴. About eleven pounds of HDPP pellets are mixed with approximately 0.01 pounds (0.1%) of CuST powder, approximately 0.01 pounds (0.1%) of AgST powder and approximately 10 ml of mineral oil and stirred until the powders coated the pellets. It should be appreciated that these ratios may be altered by +/−10% and still be within the teachings of the invention. The coated pellets are introduced into the TIM. The TIM melt temperature is about 193° C. (380° F.) and the mold temperature is about 13° C. (55° F.). The TIM samples are collected and representative samples are sent to a third-party laboratory for antimicrobial testing. Using the JIS Z 2801 test protocol, the samples demonstrate about 99.8% reduction⁵ in E. coli. The difference in efficacy between sample 1 and sample 2 is attributed to the lower concentration of CuST and AgST in sample 2 relative to sample 1.

### Example 3

Polypropylene (Lyondellbasell Moplen HP552F) pellets are prepared by polymer extrusion⁶. Approximately twenty-five pounds of polypropylene pellets are mixed with approximately 1.8 pounds of CuST powder and shaken until the powder coats the pellets. The coated pellets are introduced into the polymer extruder. Extruder processing temperatures is about 204° C. (400° F.). The extruded nominal 1/16-inch diameter rods are cut into about ⅛-inch-long pieces, collected and used for subsequent polymer processing.

The polypropylene rods with CuST are masterbatches with Polypropylene (Lyondellbasell Moplen HP552F) at about a 10:1 drawdown. In a first process, the extruded threads are spun into yarn and the yarns woven into fabric. Using the AATCC 100 test protocol the samples demonstrate about an 85% reduction⁷ in E. coli.

In a second test, the extruded threads are spun into yarn with a ratio of about 10:1 regular polypropylene threads to polypropylene threads with CuST, and the yarns woven into fabric. Using the AATCC 100 test protocol the samples demonstrate about an 7.7% reduction⁸ in E. coli. The difference in efficacy is attributed to the greater number of threads with CuST in the first test relative to the second test.

### Example 4

Polyethylene (PE) pellets are prepared by polymer extrusion⁹. About 100 pounds of PE is introduced into a commercial polymer pelletizing machine. About 7.5 pounds of CuST powder is added to the extruder using a powder feeder. Extruder processing temperatures range from about 132° C. (270° F.) to 149° C. (300° F.). The extruded pellets are collected and used as a masterbatch for subsequent polymer processing¹⁰. Using the JIS Z 2801 test protocol, the samples demonstrate about 99.9% reduction¹¹ in E. coli.

TIM is used to make polypropylene (PP), polyethylene (PE), and Acrylonitrile Butadiene Styrene (ABS) samples.

In some disclosed embodiments, polymer extrusion may be used to make polypropylene (PP), polyvinyl chloride (PVC), Polyurethane (PU) and Thermoplastic Polyurethane (TPU) samples.

In some disclosed embodiments, polymer pelletizing may be used to make polyethylene (PE) samples.

In some disclosed embodiments, commercially available colorants may be added to the polymer resins.

Having described a particular embodiment of the present disclosure, it will be apparent that modifications and variations are possible without departing from the scope of the invention as defined in the appended claims. Furthermore, it should be appreciated that all examples provided in the present disclosure, while illustrating a particular embodiment of the invention, are provided as non-limiting examples and are, therefore, not to be taken as limiting the various aspects so illustrated.

### REFERENCES

The following references are referred to above and are incorporated herein by reference:

1. http://www.ptonline.com/articles/how-to-select-the-right-pelletizer.
2. E2 Inc., Waukegan, DMRI Experimental Data 020312, sample 020312.7-02.
3. JIS Z 2801 Study Report NG3211, sample 020312.7-02.
4. E2 Inc., Waukegan, IL DMRI Experimental Data 020312, sample 020312.5-02B.
5. JIS Z 2801 Study Report NG3211, sample 020312.5-02B.

### 6. Colors for Plastics, Elk Grove Village, IL, DMRMB021413004SK.

### 7. JIS Z 2801 Study Report NG4330, Trial 1.

### 8. JIS Z 2801 Study Report NG4330, Trial 2.

### 9. PolyPlastics Inc., Elgin Il.

### 10. Dyvex Industries, Carbondale, PA, 2015-08-20-Marc-Dyvex Let Down Calculations.

11. JIS Z 2801 Study Report NG7124, thermoplastic sample.

All documents, patents, journal articles and other materials cited in the present application are incorporated herein by reference.

While the present invention has been disclosed with references to certain embodiments, numerous modification, alterations, and changes to the described embodiments are possible without departing from the sphere and scope of the present invention, as defined in the appended claims. Accordingly, it is intended that the present invention not be limited to the described embodiments, but that it has the full scope defined by the language of the following claims, and equivalents thereof.

What is claimed is:

1. A product comprising:
a polymer host matrix comprising a thermoplastic, and
one or more antimicrobial organometallic additives dispersed throughout the polymer host matrix,
wherein each of the one or more antimicrobial organometallic additives has a decomposition temperature less than about 200° C. (392° F.),
wherein each of the one or more antimicrobial organometallic additives is water insoluble or sparingly soluble in water and comprises a long-chain fatty acid group, and
wherein a majority of metallic species dispersed throughout the polymer host matrix are in the one or more antimicrobial organometallic additives.

2. The product of claim 1, wherein the one or more antimicrobial organometallic additives comprise silver stearate.

3. The product of claim 1, wherein the one or more antimicrobial organometallic additives comprise copper stearate.

4. The product of claim 1, wherein the one or more antimicrobial organometallic additives comprise zinc stearate.

5. The product of claim 1, wherein the one or more antimicrobial organometallic additives comprise a mixture of two or more members of the group consisting of the following antimicrobial organometallic additives: silver stearate, copper stearate and zinc stearate.

6. The product of claim 1, wherein the product has a degree of antimicrobial activity of 99% or greater.

7. The product of claim 6, wherein the one or more antimicrobial organometallic additives together comprise no more than about 3% by volume of the total volume of the polymer host matrix and the one or more antimicrobial organometallic additives.

8. The product of claim 1, wherein the product comprises a coating and a substrate, and wherein the polymer host matrix is at least part of the coating.

9. A method comprising the following step:
(a) mixing one or more antimicrobial organometallic additives with a liquid thermoplastic below a processing temperature to form a polymer product comprising the one or more antimicrobial organometallic additives dispersed throughout the polymer host matrix,
wherein each of the one or more antimicrobial organometallic additives is water insoluble or sparingly soluble in water and comprises a long-chain fatty acid group,
wherein a majority of metallic species dispersed throughout the polymer host matrix are in the one or more antimicrobial organometallic additives.

10. The method of claim 9, wherein the processing temperature comprises a decomposition temperature of each of the one or more antimicrobial organometallic additives.

11. The method of claim 10, wherein the decomposition temperature of each of the one or more antimicrobial organometallic additives is less than about 200° C. (392° F.).

12. The method of claim 9, wherein the one or more antimicrobial organometallic additives comprise silver stearate.

13. The method of claim 9, wherein the one or more antimicrobial organometallic additives comprise copper stearate.

14. The method of claim 9, wherein the one or more antimicrobial organometallic additives comprise zinc stearate.

15. The method of claim 9, wherein the one or more antimicrobial organometallic additives comprise a mixture of two or more members of the group consisting of the following antimicrobial organometallic additives: silver stearate, copper stearate and zinc stearate.

16. The method of claim 9, wherein the polymer product has a degree of antimicrobial activity of 99% or greater.

17. The method of claim 16, wherein the one or more antimicrobial organometallic additives together comprise no more than about 3% by volume of the total volume of the polymer host matrix and the one or more antimicrobial organometallic additives.

18. The method of claim 9, wherein the method comprises the following step:
(b) applying the polymer product to a substrate to form a coating on the substrate.

19. A product comprising:
a polymer host matrix comprising a thermoplastic and
one or more antimicrobial organometallic additives dispersed throughout the polymer host matrix,
wherein each of the one or more antimicrobial organometallic additives has a decomposition temperature less than about 200° C. (392° F.),
wherein the one or more antimicrobial organometallic additives comprise a mixture of two or more members of the group consisting of the following antimicrobial organometallic additives: silver stearate, cupric stearate and zinc stearate.

20. The product of claim 19, wherein the product has a degree of antimicrobial activity of 99% or greater, and wherein the one or more antimicrobial organometallic additives together comprise no more than about 3% by volume of the total volume of the polymer host matrix and the one or more antimicrobial organometallic additives together.
